(19) United States
(12) Patent Application Publication
(10) Pub. No.: US 2006/0279646 A1
(43) Pub. Date: Dec. 14, 2006

(54) Pixel defect detection method for solid-state image pickup device

(75) Inventor: Masayuki Koyanagi, Kurokawa-gun (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/444,482

(22) Filed: Jun. 1, 2006

(30) Foreign Application Priority Data
Jun. 9, 2005 (JP) P2005-169599

(51) Int. Cl. H04N 9/64

(52) U.S. Cl. 348/246

(57) ABSTRACT

A pixel defect detection method for a solid-state image pickup device that comprises photoelectric conversion devices and a charge transfer path so as to extract signal charges accumulated on the photoelectric conversion devices to the charge transfer path, the method comprising: imaging, under illumination light of a first light amount, the solid-state image pickup device, to generate a set of first picked-up image signals corresponding to the photoelectric conversion devices and detect at least one first defective pixel where corresponding one of the first picked-up image signals is below a first level; and imaging, under illumination light of a second light amount smaller than the first light amount, the solid-state image pickup device, to generate a set of second picked-up image signals corresponding to the photoelectric conversion devices and detect at least one second defective pixel where corresponding one of the second picked-up image signals is below a second level.

### BACKGROUND OF THE INVENTION

1. Field of the Invention

The present invention relates to a pixel defect detection method for a solid-state image pickup device that transfers accumulated electric charges to output a signal.

2. Description of the Related Art

A charge coupled device (CCD) is widely used for a solid-state image pickup device. Pixels in the CCD may contain defects (pixel defects) attributable to adhesion of dust and crystal defects. A normal signal may not be output from such defective pixels. CCD manufacturers may check the defective pixels in the company and provide a manufacturer of equipment mounting a CCD with address information representing the position of a defective pixel. In case such information is available, the equipment manufacturer may use the information to correct the defective pixel.

When detection of pixel defect is made by a CCD manufacturer under the influence of noise, too large an amount of detect information is obtained and the probability of a defective pixel occurring in the adjacent position increases, which may prevent correction of the defective pixel. Moreover, as disclosed in JP-A-05-68209, too large an amount of detective pixel information may disadvantageously require a large memory capacity in case defective pixel information is stored in a volatile memory such as a ROM and the information is referenced to correct a defective pixel.

From the above reasons, a defective pixel is generally detected at a relatively high signal level in order to reduce the influence of noise. For example, light amount is adjusted so that the signal amount of one third to half the electric charge saturation level with respect to the photodiode for each pixel of CCD will be output.

When a CCD manufacturer inspects pixel defects at a high signal level, a pixel whose sensitivity is reduced (defective pixel), if any, is detected as an isolated point or anon-continuous scratch. Lowering the signal level may locally reduce the signal charge transfer efficiency upstream in the signal charge transfer direction for the pixel containing the pixel defect, thus generating a continuous signal defect. In general, the lower the signal level, the lower the transfer efficiency. Thus, a continuous pixel defect is more likely to occur as the signal level drops.

However, detecting pixel defects at a high signal level alone makes it difficult to detect a continuous scratch as a continuous pixel defect. Thus, such a continuous scratch is not a target of defective pixel correction of the pixel defect. As a result, when the signal level is high, it is possible to obtain an output image of a solid-state image pickup device of which correction is effective. When the signal level is low, the output image data obtained includes only a non-corrected, degraded image.

### SUMMARY OF THE INVENTION

The invention has been accomplished in view of the above circumstances. An object of the invention is to provide a pixel defect detection method for a solid-state image pickup device capable of detecting a continuous scratch as a continuous pixel detect caused by transfer failure on a charge transfer path by extracting a pixel whose gradation value is at a low level for both of a case where the CCD signal level is low and a case where the CCD signal level is high and combining the extraction results.

The above object of the invention is attained by the following configurations:

(1) A pixel defect detection method for a solid-state image pickup device that comprises a plurality of photoelectric conversion devices and a charge transfer path so as to extract signal charges accumulated on the photoelectric conversion devices to the charge transfer path and output the signal charges the method comprising: imaging, under illumination light of a first light amount, with the solid-state image pickup device, to generate a set of first picked-up image signals corresponding to said plurality of photoelectric conversion devices respectively and detect at least one first defective pixel where corresponding one of the first picked-up image signals is below a first level; and imaging, under illumination light of a second light amount smaller than the first light amount, with the solid-state image pickup device, to generate a set of second picked-up image signals corresponding to said plurality of photoelectric conversion devices respectively and detect at least one second defective pixel where corresponding one of the second picked-up image signals is below a second level.

With this pixel defect detection method for a solid-state image pickup device, detection of a pixel defect is made by using a picked-up image signal through the illumination light of the predetermined light amount (the first light amount) as well as a picked-up image signal obtained by shooting under illumination light of a light amount (the second light amount) smaller than the predetermined light amount (the first light amount). This reliably detects a pixel defect that is likely to occur as the electric charge efficiency generally drops for a lower light amount, thereby more accurately detecting a pixel defect.

(2) The pixel defect detection method for a solid-state image pickup device according to (1), wherein, among each of said at least one first defective pixel and said at least one second defective pixel, only a group of pixels in mutually continuous positions is registered as defective pixels, and an isolated pixel is excluded from defective pixels.

With this pixel defect detection method for a solid-state image pickup device, only a group of pixels in mutually continuous positions is registered as a pixel defect and an isolated pixel is excluded from the pixel detects, so that it is possible to prevent too much defective pixel information from being obtained.

### BRIEF DESCRIPTION OF THE DRAWINGS

FIG. 1 is a block diagram showing a general configuration of pixel defect inspection apparatus for performing the inventive pixel defect detection method;

FIG. 2 is a flowchart showing an example of the pixel defect detection method according to the invention;

FIG. 3A is an explanatory drawing illustrating an example of the extraction result of a low-level pixel at a high signal level;

FIG. 3B is an explanatory drawing illustrating an example of the extraction result of a low-level pixel at a low signal level; and

FIG. 4 is a graph showing the relationship between a signal level from the CCD and a scratch level.

### DETAILED DESCRIPTION OF THE INVENTION

Preferable embodiments of the pixel defect detection method for a solid-state image pickup device according to the invention will be detailed referring to drawings.

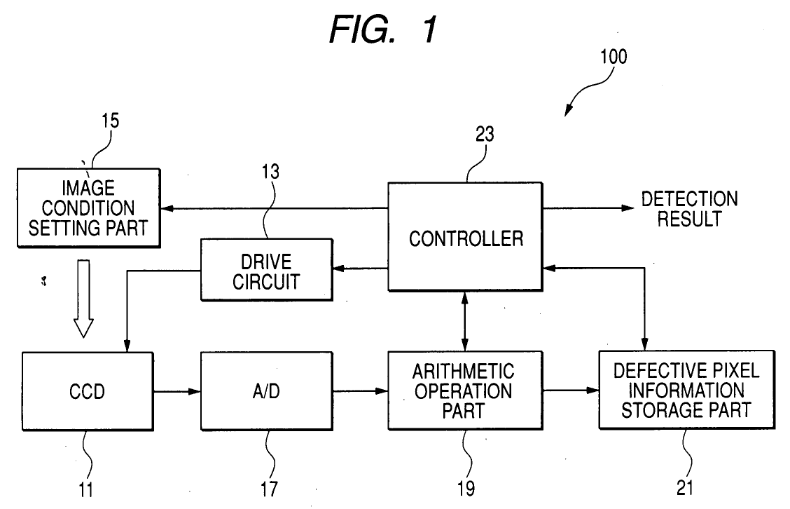

FIG. 1 is a block diagram showing a general configuration of pixel defect inspection apparatus for performing the inventive pixel defect detection method.

Pixel defect inspection apparatus 100 comprises: a drive circuit 13 for driving a CCD 11 as an inspection target; an imaging condition setting part 15 for setting imaging conditions such as illumination in imaging with the CCD 11; an A/D converter 17 for converting a picked-up image signal to a digital signal with the CCD 11; an arithmetic operation part 19 for performing predetermined processing to detect a pixel defect for a digitized picked-up image signal; a defective pixel information storage part 21 for storing the position information of a detected pixel defect; and a controller 23 for controlling these parts and outputting the detection result of a pixel defect.

The imaging condition setting part 15 includes an illumination light source for the CCD 11 and causes the illumination light source to emit light with a predetermined light amount (the first light amount) to illuminate the CCD 11 based on directive from the controller 23.

The arithmetic operation part 19 processes for example 8-bit gradation digital image data input after a picked-up image signal output from the CCD 11 following the imaging process is A/D converted, thus extracting a pixel whose gradation value is below a predetermined level and outputting the pixel defect to the defective pixel information storage part 21.

The pixel defect detection method using thus configured pixel defect inspection apparatus 100 will be detailed.

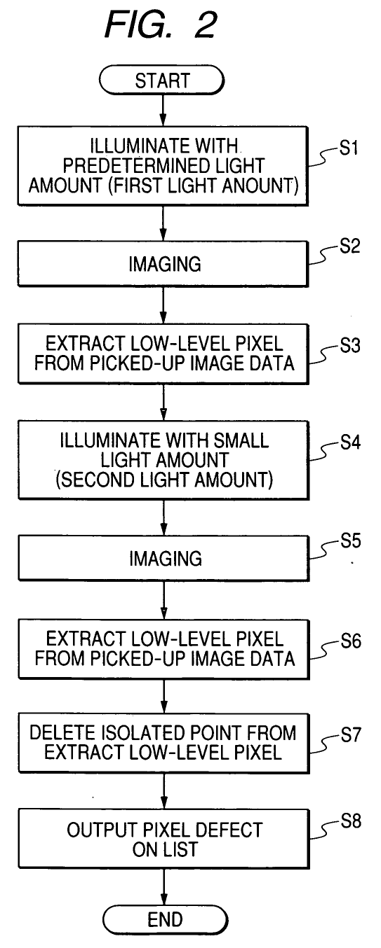

FIG. 2 is a flowchart showing an example of the pixel defect detection method according to the invention.

While the pixel defect detection method will be sequentially described based on FIG. 2, the pixel defect detection method is not limited to the procedures of this example but may be modified as required.

First, the controller 23 causes the imaging condition setting part 15 to illuminate the CCD 11 with a predetermined light amount (the first light amount) (step 1, hereinafter abbreviated as S1). The predetermined light amount (the first light amount) is an illumination light amount within 30 to 50 percent of the electric charge saturation level of the output signal amount from the CCD 11 with respect to the photodiode for each pixel of CCD. A picked-up image signal is transmitted to the CCD 11 by the drive circuit 13 and the CCD 11 performs imaging (S2). From the picked-up image data obtained from the imaging process, a low-level pixel whose gradation value is below a predetermined level (first level) is extracted (S3). Pixel information including the gradation value of the extracted low-level pixel and pixel position is output to the defective pixel information storage part 21 and saved therein.

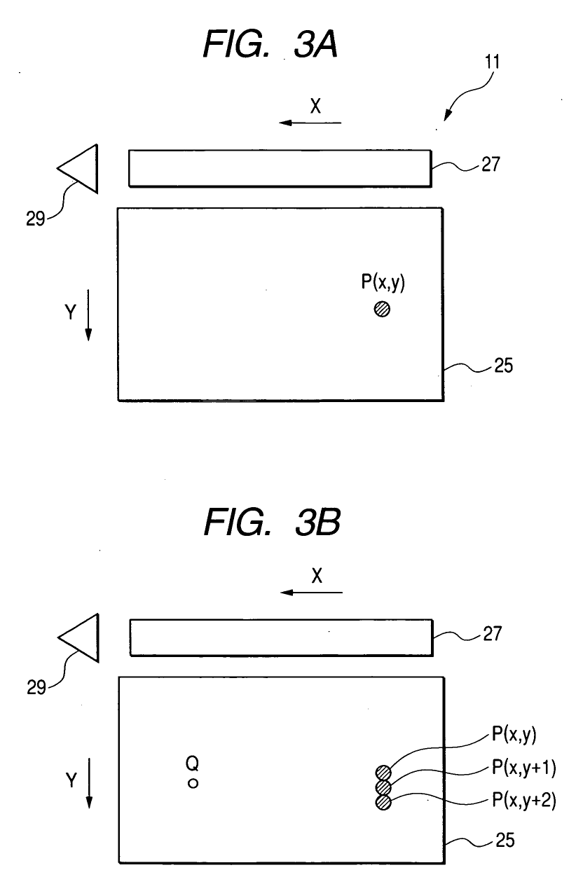

FIG. 3A shows an example of extraction result of a low-level pixel. The CCD 11 comprises an imaging area 25 including a photodiode as a photoreceptor and a vertical charge transfer path, a horizontal charge transfer path 27, and an output amplifier 29, and their positions are as shown in FIG. 3A. In this example, a low-level pixel is extracted at the point P (x,y) in the imaging area 25

Next, the imaging condition setting part 15 is illuminated with a light amount (the second light amount) smaller than the predetermined light amount (S4). The smaller light amount (the second light amount) is a is an illumination light amount within 5 to 10 percent of the electric charge saturation level of the output signal amount from the CCD 11 with respect to the photodiode for each pixel of CCD. Under the illumination with the small light amount (the second light amount), the drive circuit 13 causes the CCD 11 to perform imaging (S5). From the picked-up image data obtained through the imaging process, a low-level pixel whose gradation value is below a predetermined level (second level) is extracted (S6). Pixel information including the gradation value of the extracted low-level pixel and pixel position is also output to the defective pixel information storage part 21 and saved therein.

Next, the controller 23 assumes, from the information on the extracted low-level pixel saved in the defective pixel information storage part 21, that P1(x,y+1), P2(x,y+2) adjacent the point P shown in FIG. 3B in y direction and another position Q have been extracted as low-level pixel positions. A group of continuous pixels P, P1 and P2 in the raw image data appears as a continuous scratch observed as low-luminance black dripping that is a non-negligible defect. Defects are continuous in y direction because local transfer failure on the vertical charge transfer path results in a pixel defect starting with the defective pixel in the local position and pixels upstream in the charge transfer direction that continues from the defective pixel.

An isolated pixel such as the point Q that has not been extracted adjacently to other pixels is excluded from the pixel defect (S7). Registering an isolated pixel as a pixel defect could result in excessive defective pixel information because a low-level signal contains more noise. Thus, such an isolated point is deleted from defective pixel information and only a continuous pixel defect is extracted as a pixel defect. By detecting only a pixel defect (black defect) with lower sensitivity, it is possible to further reduce the defective pixel information amount.

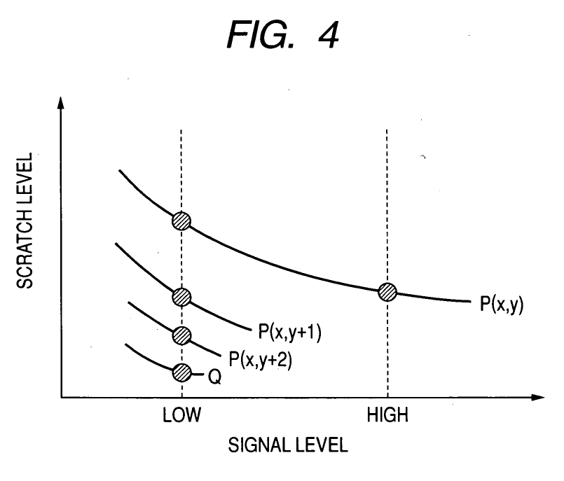

FIG. 4 shows the relationship between a signal level from the CCD and a scratch level. The scratch level refers to the ratio of the measured detection level to the output level from the CCD under normal operation. The smaller this value is, the more likely is the defect to be visually recognized as a scratch.

In case the level of a signal from the CCD 11 is high, only the point P is extracted and the scratch level is evaluated on a single point alone. In case the signal level is low, the points P1, P2 and Q as well as P are extracted. The point Q as an isolated point is deleted from candidates for an image defect. As a result, a group of pixels P, P1 and P2 continuous in y direction is listed as the detection result of a pixel defect, and the pixel information is output (S8).

By way of the above procedure, it is possible to reliably detect a pixel whose gradation value is at a low level that occurs only when the level of an output signal from the CCD 11 is low. This allows accurate detection of a pixel defect of the CCD 11 without fail.

The foregoing pixel defect detection procedure is only exemplary. Continuous imaging may be made for a case where the CCD output signal level is low and a case where the CCD output signal level is high and the picked-up images may be processed to detect a pixel defect. Or, a pixel defect may be detected in a desired number of stages instead of the two levels, high and low. Adjustment of an output signal level may use an electronic shutter as well as the illumination light amount.

According to the inventive pixel defect detection method for a solid-state image pickup device, it is possible to detect a continuous scratch as a continuous pixel detect caused by transfer failure on a charge transfer path by extracting a pixel whose gradation value is at a low level for both of a case where the CCD signal level is low and a case where the CCD signal level is high and combining the extraction results.

The entire disclosure of each and every foreign patent application from which the benefit of foreign priority has been claimed in the present application is incorporated herein by reference, as if fully set forth.

What is claimed is:

1. A pixel defect detection method for a solid-state image pickup device that comprises a plurality of photoelectric conversion devices and a charge transfer path so as to extract signal charges accumulated on the photoelectric conversion devices to the charge transfer path and output the signal charges, the method comprising:
imaging, under illumination light of a first light amount, with the solid-state image pickup device, to generate a set of first picked-up image signals corresponding to said plurality of photoelectric conversion devices respectively and detect at least one first defective pixel where corresponding one of the first picked-up image signals is below a first level; and
imaging, under illumination light of a second light amount smaller than the first light amount, with the solid-state image pickup device, to generate a set of second picked-up image signals corresponding to said plurality of photoelectric conversion devices respectively and detect at least one second defective pixel where corresponding one of the second picked-up image signals is below a second level.

2. The pixel defect detection method for a solid-state image pickup device according to claim 1,
wherein, among each of said at least one first defective pixel and said at least one second defective pixel, only a group of pixels in mutually continuous positions is registered as defective pixels, and an isolated pixel is excluded from defective pixels.
